(19) United States
(12) Patent Application Publication
(10) Pub. No.: US 2025/0202020 A1
(43) Pub. Date: Jun. 19, 2025

(54) BATTERY CASE FOR ELECTRIC VEHICLE AND PRODUCTION METHOD THEREFOR

(71) Applicants: Kabushiki Kaisha Kobe Seiko Sho (Kobe Steel, Ltd.), Kobe-shi (JP); TOYOTA JIDOSHA KABUSHIKI KAISHA, Toyota-shi (JP)

(72) Inventors: Hideki ISHITOBI, Kobe-shi (JP); Kouichi DAIGAKU, Okazaki-shi (JP)

(73) Assignees: Kabushiki Kaisha Kobe Seiko Sho (Kobe Steel, Ltd.), Kobe-shi (JP); TOYOTA JIDOSHA KABUSHIKI KAISHA, Toyota-shi (JP)

(21) Appl. No.: 18/843,895

(22) PCT Filed: Mar. 8, 2023
(86) PCT No.: PCT/JP2023/008867

§ 371 Date: Sep. 4, 2024

(30) Foreign Application Priority Data
Mar. 9, 2022 (JP) 2022-036044

(51) Int. Cl. H01M 50/262; H01M 50/224; H01M 50/242; H01M 50/249

(52) U.S. Cl. CPC H01M 50/262; H01M 50/224; H01M 50/242; H01M 50/249

(57) ABSTRACT

An electric vehicle battery case includes: a frame formed in a polygonal frame shape when viewed from a vehicle vertical direction by joining a plurality of framework members, the frame configured to define a space inside; and a tray configured to house a battery, the tray having a bathtub shape disposed at least partially in the space of the frame. The plurality of framework members and include a first framework member that is made of an aluminum extruded material and has a first engagement portion at an end portion and a second framework member that is made of an aluminum extruded material and has a second engagement portion at an end portion. The first and second engagement portions have shapes to be engaged with each other. The first framework member and the second framework member are directly joined by engagement of the first and second engagement portions.

### TECHNICAL FIELD

The present disclosure relates to an electric vehicle battery case and a method for manufacturing the same.

### BACKGROUND ART

An electric vehicle such as an electric car needs to mount a large capacity battery in order to secure a sufficient cruising distance, and on the other hand, the electric vehicle is required to include a wide vehicle interior. In order to satisfy both these requirements, in many electric cars, a large-capacity battery is housed in a battery case and mounted on the entire underfloor surface of the vehicle. Therefore, the electric vehicle battery case is required to have high sealing performance for preventing water from entering from a road surface or the like to prevent malfunctions of electronic components, and high collision strength is required to protect the internal battery.

For example, Patent Document 1 discloses a battery case in which sealing performance is improved by using a tray obtained by forming a metal plate into a bathtub shape by cold press forming.

### PRIOR ART DOCUMENTS

### Patent Documents

Patent Document 1: JP 2017-226353 A

### SUMMARY OF THE INVENTION

### Problems to be Solved by the Invention

In the battery case of Patent Document 1, the sealing performance is improved by a bathtub-shaped tray, but in order to form a frame for housing the tray, it is necessary to join the longitudinal frame, the front beam, and the rear beam by joining means such as welding. In particular, when welding is used as the joining means, not only the manufacturing step becomes complicated but also thermal damage may occur.

An object of the present disclosure is, in an electric vehicle battery case and a method for manufacturing the same, to improve sealing performance by a bathtub-shaped tray, and to simply configure a frame for housing the tray without thermal damage.

### Solutions to the Problems

A first aspect of the present disclosure provides an electric vehicle battery case including: a frame formed in a polygonal frame shape when viewed from a vehicle vertical direction by joining a plurality of framework members, the frame configured to define a space inside; and a tray having a bathtub shape configured to house a battery, the tray disposed at least partially in the space of the frame. The plurality of framework members includes a first framework member that is made of an aluminum extruded material and has a first engagement portion at an end portion, and a second framework member that is made of an aluminum extruded material and has a second engagement portion at an end portion. The first engagement portion and the second engagement portion have shapes to be engaged with each other. The first framework member and the second framework member are directly joined by engagement of the first engagement portion and the second engagement portion.

According to this configuration, by engaging the first engagement portion with the second engagement portion, the first framework member and the second framework member are directly joined, so that complicated welding is not required. Therefore, thermal damage to the frame can be suppressed, and the frame can be simply configured. Here, the engagement refers to fitting that structurally involves positional restraint without requiring an additional joining means such as welding. Since accurate positioning is achieved by fitting with such structural positional restraint, dimensional accuracy and joining accuracy can be improved. In addition, since the tray is formed in a bathtub shape, there is no joint in the tray, and high sealing performance capable of preventing water from entering from a road surface or the like can be secured.

At least one of the first engagement portion and the second engagement portion may have a recessed shape.

According to this configuration, the engagement structure of the first engagement portion and the second engagement portion can be specifically implemented. Accordingly, the first engagement portion and the second engagement portion can be engaged with each other by fitting a recessed shape of the other thereof into a recessed shape of one thereof.

The first engagement portion may include a recessed portion having a shape recessed downward in the vehicle vertical direction. The second engagement portion may include a recessed portion having a shape recessed upward in the vehicle vertical direction.

According to this configuration, the engagement structure of the first engagement portion and the second engagement portion can be further specifically implemented. In particular, the recessed portions recessed in the vehicle vertical direction are fitted to each other, so that the positions of the first framework member and the second framework member in the horizontal direction are restrained. In addition, since the bathtub-shaped tray is disposed on the frame from above, the first engagement portion and the second engagement portion may be covered with the tray. Therefore, the position in the vehicle vertical direction is also restrained, and the engagement can be prevented from being released.

The tray may be brought into pressure contact with the frame.

According to this configuration, the frame and the tray can be easily integrated without requiring welding.

A negative angle portion in which a negative angle directed at least partially inward in a horizontal direction from a bottom wall of the tray toward an upper side in the vehicle vertical direction is formed may be provided.

According to this configuration, even when an upward force is applied to the tray, the negative angle portion is caught by the frame, so that the tray can be prevented from being detached from the frame. That is, the pressure contact between the tray and the frame can be prevented from being released.

A corner member having a curved surface may be disposed at an inner corner portion of the frame when viewed from the vehicle vertical direction.

According to this configuration, at the time of the pressure contact, the tray is pressed against the curved surface, at the inner corner portion of the frame. If the corner member is not disposed, there is a risk that the corner portion of the tray is broken due to concentration of strain. However, when the corner member is disposed as in the above configuration, since the corner portion of the tray is supported by the corner member at the time of the pressure contact, the concentration of stress on the corner portion of the tray can be suppressed, and cracking of the tray can be suppressed. Here, the curved shape may be, for example, a circular arc shape.

A second aspect of the present disclosure provides a method for manufacturing an electric vehicle battery case, the method including: preparing a member to be formed having a flat-plate shape and a plurality of framework members, the plurality of framework members including a first framework member that is made of an aluminum extruded material and has a first engagement portion at an end portion and a second framework member that is made of an aluminum extruded material and has a second engagement portion at an end portion, the first engagement portion and the second engagement portion having shapes to be engaged with each other; joining the first framework member and the second framework member by engaging the first engagement portion and the second engagement portion to form a frame having a polygonal frame shape when viewed from a vehicle vertical direction and defining a space inside; superposing and disposing the member to be formed on the frame; and applying pressure to the member to be formed from a side opposite to that of the frame, pressing the member to be formed against the frame, swelling the member to be formed in the space, resulting in deforming the member to be formed into a tray having a bathtub shape and bringing the member to be formed into pressure contact with the frame.

According to this method, by engaging the first engagement portion with the second engagement portion, the first framework member and the second framework member are directly joined, so that complicated welding is not required. Therefore, thermal damage to the frame can be suppressed, and the frame can be simply configured. Here, the engagement refers to fitting that structurally involves positional restraint without requiring an additional joining means such as welding. Since accurate positioning is performed by fitting with such structural positional restraint, dimensional accuracy and joining accuracy can be improved. In addition, since the tray is formed in a bathtub shape, there is no joint in the tray, and high sealing performance capable of preventing water from entering from a road surface or the like can be secured. In addition, by the pressure contact, the frame and the tray can be easily integrated without requiring welding. At this time, the manufacturing step can be simplified by simultaneously performing the forming of the bathtub-shaped tray and the pressure contact between the tray and the frame.

### Effects of the Invention

According to the present disclosure, in an electric vehicle battery case and a method for manufacturing the same, it is possible to improve sealing performance by a bathtub-shaped tray, and to simply configure a frame for housing the tray without thermal damage.

### BRIEF DESCRIPTION OF DRAWINGS

FIG. 1 is a side view of an electric car mounting an electric vehicle battery case according to a first embodiment of the present disclosure;

FIG. 2 is a schematic cross-sectional view of the battery case;

FIG. 3 is a perspective view of the battery case;

FIG. 4 is an exploded perspective view of the battery case;

FIG. 5 is an exploded perspective view of a frame;

FIG. 6 is a plan view of a tray;

FIG. 7 is a perspective view of a member to be formed, a first framework member, and a second framework member;

FIG. 8 is a first cross-sectional view showing a method for manufacturing the battery case;

FIG. 9 is a second cross-sectional view showing a method for manufacturing the battery case;

FIG. 10 is a third cross-sectional view showing a method for manufacturing the battery case;

FIG. 11 is a fourth cross-sectional view showing a method for manufacturing the battery case;

FIG. 12 is a cross-sectional view showing a first modification of negative angle forming;

FIG. 13 is a cross-sectional view showing a second modification of negative angle forming;

FIG. 14 is a schematic cross-sectional view of a battery case showing a modification of the closing plate;

FIG. 15 is an exploded perspective view of a frame in a modification;

FIG. 16 is a perspective view of a frame of a battery case according to a second embodiment;

FIG. 17 is an exploded perspective view of a frame FIG. 18 is a perspective view of a frame in a modification; and

FIG. 19 is an exploded perspective view of a frame in a modification.

### DETAILED DESCRIPTION

Hereinafter, embodiments of the present disclosure will be described with reference to the accompanying drawings.

### First Embodiment

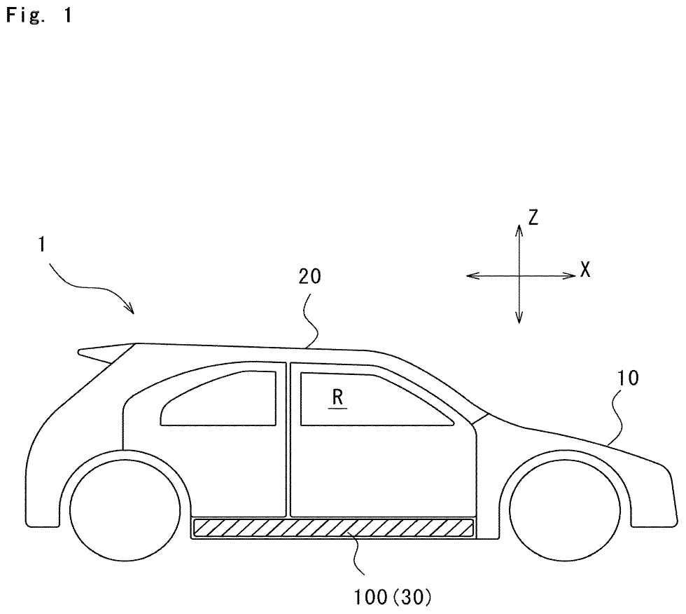

Referring to FIG. 1, an electric vehicle 1 is a vehicle that travels by driving a motor (not shown) by electric power supplied from a battery 30. For example, the electric vehicle 1 may be an electric car, a plug-in hybrid vehicle, or the like. The type of the vehicle is not particularly limited, and may be a passenger car, a truck, a maintenance vehicle, other mobility, or the like. Hereinafter, a case of a passenger car type electric vehicle as the electric vehicle 1 will be taken as an example to be described.

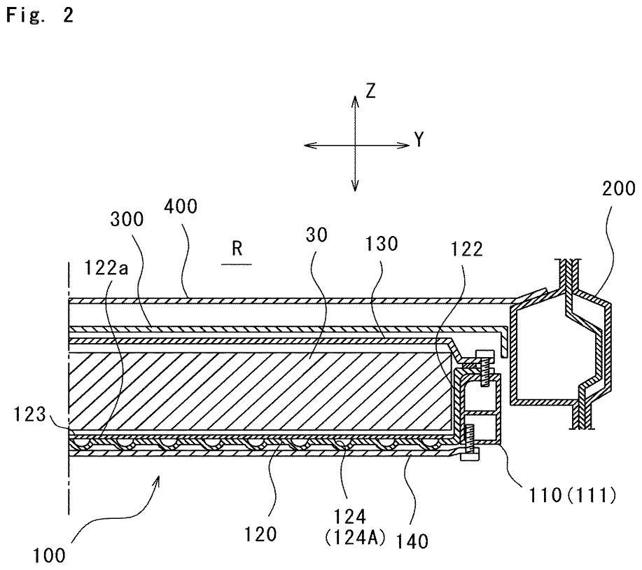

The electric vehicle 1 mounts a motor, a high-voltage apparatus, and the like (not shown) in the vehicle body front portion 10. In addition, the electric vehicle 1 mounts an electric vehicle battery case 100 (hereinafter, also simply referred to as a battery case 100) in which a battery 30 is housed in substantially the entire underfloor space of the vehicle interior R of the vehicle body central portion 20. It should be noted that in FIG. 1, the front-rear direction of the electric vehicle 1 is represented by the X direction, and the vertical direction is represented by the Z direction. The same notation also applies to the following drawings, and the vehicle width direction is represented by the Y direction in FIG. 2 and subsequent figures.

Referring to FIG. 2, the battery case 100 is disposed inside the rocker member 200 in the vehicle width direction. The rocker member 200 extends in the vehicle front-rear direction at both lower ends in the vehicle width direction of the electric vehicle 1 (see FIG. 1). The rocker member 200 is formed by bonding a plurality of metal plates, and has a function of protecting the vehicle interior R and the battery case 100 against impact from the side of the electric vehicle 1.

Referring also to FIGS. 2 to 4, the battery case 100 includes a frame 110 defining a through hole TH, a tray 120 having a bathtub shape, a top cover 130 (see FIG. 2) and an under cover 140 (see FIG. 2) arranged so as to sandwich them from above and below, and a closing plate 123 arranged on a bottom wall 122a of the tray 120. Here, the through hole TH is an example of a space in the present disclosure.

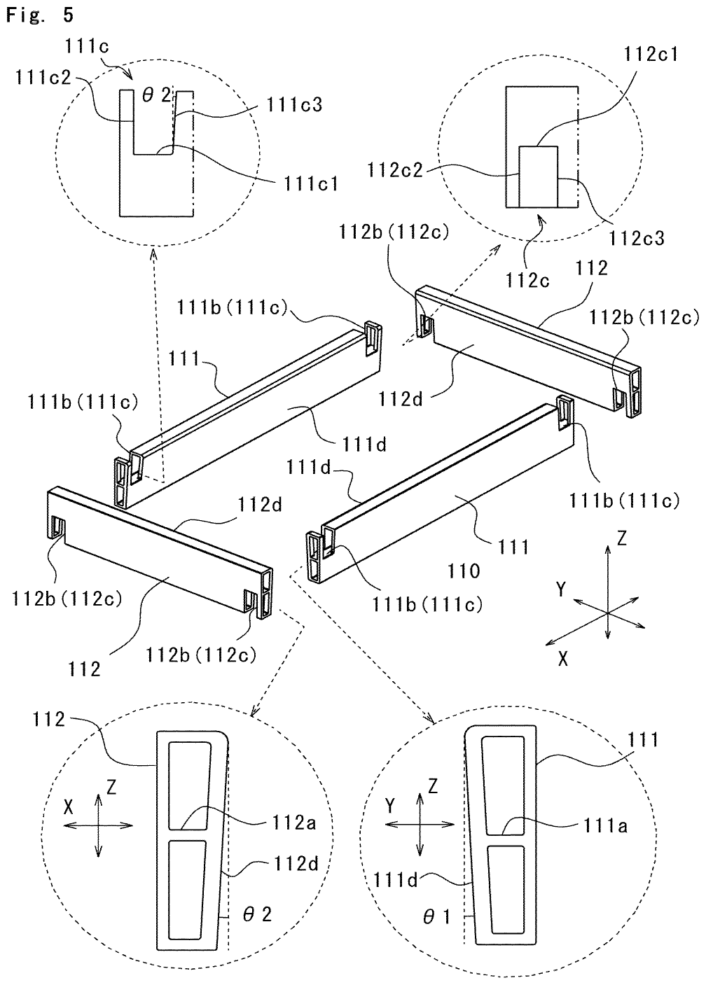

Referring also to FIG. 5, the frame 110 is a member forming the framework of the battery case 100. The frame 110 is formed in a polygonal frame shape (rectangular frame shape in the present embodiment) when viewed from the vehicle vertical direction by joining the plurality of framework members 111 and 112, and defines the through hole TH inside. Hereinafter, the inside of the frame 110 refers to the center side of the rectangular frame shape, and the outside refers to the opposite side. The plurality of framework members 111 and 112 includes two first framework members 111 and two second framework members 112.

The first framework member 111 is made of an aluminum extruded material linearly extending in the vehicle front-rear direction. The first framework member 111 has a hollow shape. The inside of the first framework member 111 is partitioned in the vehicle vertical direction by a partition wall 111a. In the cross-section perpendicular to the vehicle front-rear direction, the first framework member 111 is inclined by an angle θ1 from the vertical direction so that the inclined surface 111d on the inner side in the vehicle width direction narrows the through hole TH as it goes upward in the vehicle vertical direction (see the inside of the lower right broken line circle in FIG. 5). For example, the angle θ1 may be greater than or equal to 1 degree and less than or equal to 10 degrees.

In addition, the first framework member 111 has first engagement portions 111b at both end portions in the vehicle front-rear direction. The first engagement portion 111b has a recessed shape. Specifically, the first engagement portion 111b has a recessed portion 111c having a shape recessed downward in the vehicle vertical direction. The recessed portion 111c includes a bottom surface 111c1 and two side surfaces 111c2 and 111c3. The bottom surface 111c1 includes the partition wall 111a. One side surface 111c2 is provided perpendicular to the bottom surface 111c1 (that is, along the vertical direction), and the other side surface 111c3 is provided to be inclined (that is, inclined at an angle θ2 from the vertical direction) in accordance with the inclination of an inclined surface 112d of the second framework member 112 to be described below (see the inside of the upper left broken line circle in FIG. 5).

The second framework member 112 is made of an aluminum extruded material linearly extending in the vehicle width direction. The second framework member 112 has a hollow shape. The inside of the second framework member 112 is partitioned in the vehicle vertical direction by a partition wall 112a. In the cross-section perpendicular to the vehicle width direction, the second framework member 112 is inclined by an angle θ2 from the vertical direction so that the inclined surface 111d on the inner side in the vehicle front-rear direction narrows the through hole TH as it goes upward in the vehicle vertical direction (see the inside of the lower left broken line circle in FIG. 5). For example, the angle θ2 may be greater than or equal to 1 degree and less than or equal to 10 degrees.

In addition, the second framework member 112 has second engagement portions 112b at both end portions. The second engagement portion 112b has a recessed shape. Specifically, the second engagement portion 112b has a recessed portion 112c having a shape recessed upward in the vehicle vertical direction. The recessed portion 112c includes a top surface 112c1 and two side surfaces 112c2 and 112c3. The top surface 112c1 of the recessed portion 112c includes the partition wall 112a. The two side surfaces 112c2 and 112c3 of the recessed portion 112c are provided perpendicular to the top surface 112c1 (that is, along the vertical direction) (see the upper right broken line circle in FIG. 5).

The first engagement portion 111b and the second engagement portion 112b have shapes to be engaged with each other. Here, the engagement refers to fitting that structurally involves positional restraint without requiring an additional joining means such as welding. In the present embodiment, by engaging the recessed portion 111c of the first engagement portion 111b with the recessed portion 112c of the second engagement portion 112b, the first framework member 111 and the second framework member 112 are directly joined.

It should be noted that in the present embodiment, the frame 110 defining the through hole TH will be described as an example, but the shape of the frame 110 is not limited to the through shape. For example, the frame 110 may have a recessed shape instead of the penetrating shape, that is, may have a bottom wall.

In addition, in the present embodiment, the structure in which both the first engagement portion 111b and the second engagement portion 112b have shapes recessed in the vehicle vertical direction is exemplified, but the first engagement portion 111b and the second engagement portion 112b are not limited to the shapes and may have any shape capable of joining the first framework member 111 and the second framework member 112. For example, only one of the first engagement portion 111b and the second engagement portion 112b may have a structure having a recessed shape. The recessed shape is not limited to a shape recessed in the vehicle vertical direction, and may be a shape recessed in other directions. In addition, an engagement structure other than the recessed shape may be adopted.

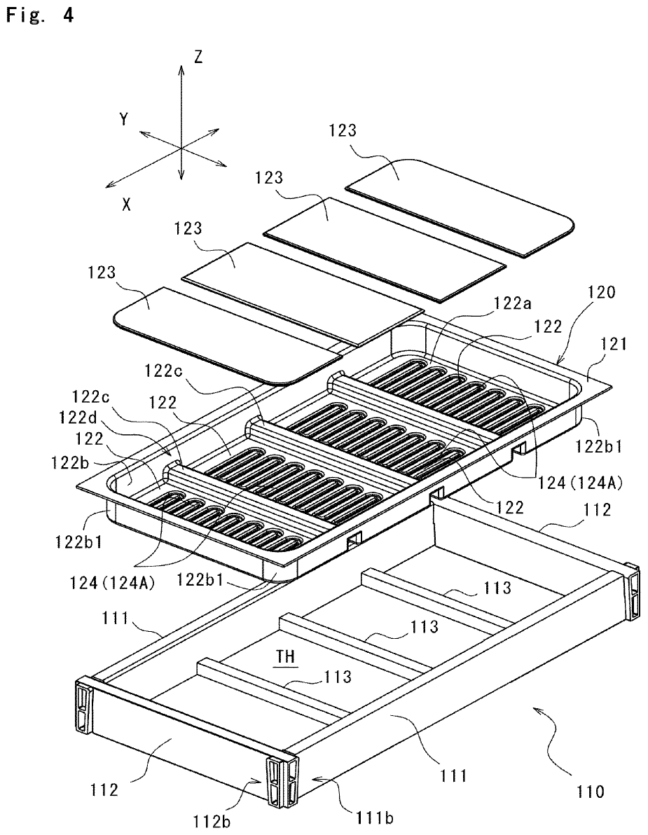

Referring again to FIG. 4, three cross members 113 are attached to the frame 110. The three cross members 113 are arranged at equal intervals in parallel with the two second framework members 112 so as to connect the two first framework members 111 in the through hole TH. The three cross members 113 have a function of improving the strength of the battery case 100. In particular, the three cross members 113 can improve strength against collision from the side of the electric vehicle 1 (see FIG. 1). It should be noted that the mode of the cross member 113 is not particularly limited, and the size, shape, arrangement, number, and the like thereof can be optionally set. In addition, the cross member 113 is not an essential configuration and may be omitted as necessary.

The tray 120 is a bathtub-shaped member that houses the battery 30. The tray 120 is made of, for example, an aluminum alloy plate material. The tray 120 includes a flange 121 extending in a horizontal direction (X-Y direction) at an outer edge portion, and a housing portion 122 being continuous with the flange 121 and having a recessed shape. The housing portion 122 is a portion that houses the battery 30 and is partially disposed in the through hole TH of the frame 110. The housing portion 122 has a bottom wall 122a constituting a bottom surface, and a peripheral wall 122b provided around the bottom wall 122a and defining an opening 122d on the opposite side from the bottom wall 122a. As will be described in detail below, the peripheral wall 122b is brought into pressure contact with the frame 110.

Three projecting portions 122c having shapes complementary to the three cross members 113 are formed on the bottom wall 122a of the housing portion 122. The three projecting portions 122c are portions where the bottom wall 122a partially projects upward and extends in the vehicle width direction. The bottom wall 122a is formed with grooves 124 through which the coolant flows in respective regions divided by the three projecting portions 122c. As will be described in detail below, the three projecting portions 122c are brought into pressure contact with the three cross members 113.

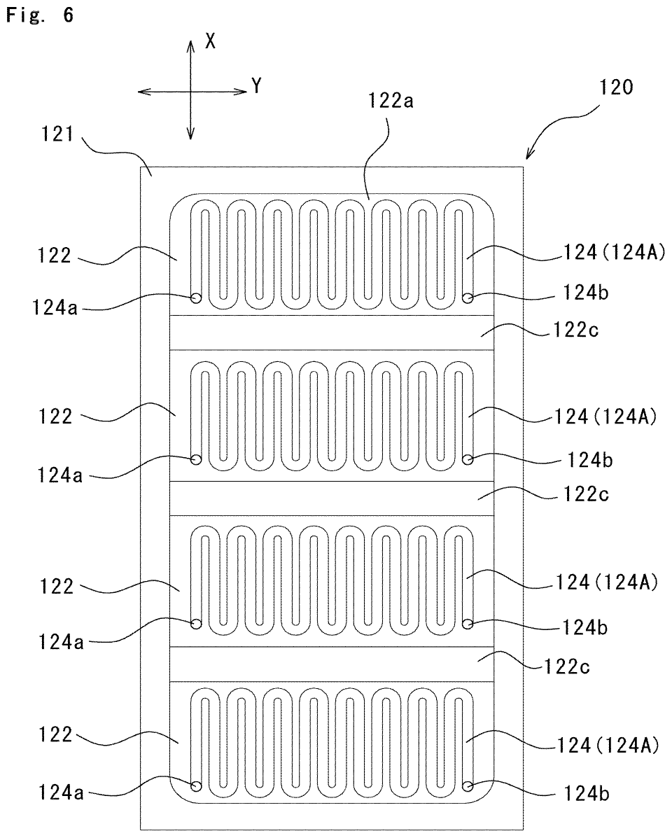

Referring to FIGS. 4 and 6, the individual groove 124 is formed in a bellows shape in plan view. One end of the individual groove 124 is provided with an inlet 124a into which a coolant flows, and the other end is provided with an outlet 124b from which the coolant flows out. In addition, the cross-sectional shape of the groove 124 is semicircular (see FIG. 2). It should be noted that a plan view shape and a cross-sectional shape of the groove 124 are not particularly limited, and may be any shape.

Referring to FIGS. 2 and 4 together, in each region of the bottom wall 122a divided by the three projecting portions 122c, a closing plate 123 of a corresponding shape is arranged and joined from above. The groove 124 is closed with the closing plate 123, and a coolant flow path 124A through which the coolant flows is defined.

A battery 30 (see FIG. 2) is disposed on the closing plate 123. The coolant flowing through the coolant flow path 124A cools the battery 30 through the closing plate 123. The closing plate 123 may be an aluminum plate or the like of high thermal conductivity in order to improve cooling efficiency.

A joining method such as an adhesive or thermal fusion (for example, laser thermal fusion) may be used when the closing plate 123 is joined to the tray 120. Preferably, friction stir welding (FSW) is used. Since the FSW is joining in a solid phase state, unlike normal welding, the FSW does not cause a blowhole and is excellent in sealing performance. In order to improve the cooling performance, the thickness of the closing plate 123 may be, for example, 2 mm or less (for example, about 1 mm).

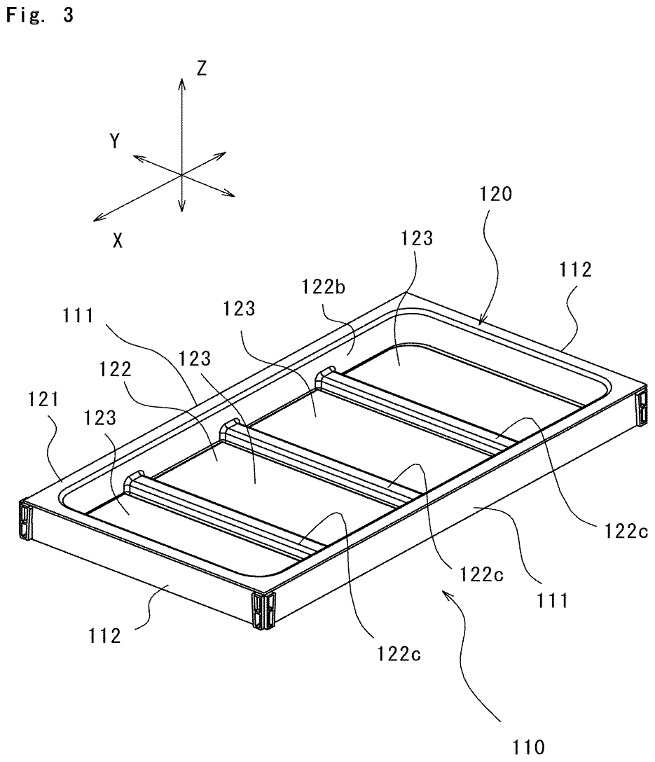

Referring to FIG. 3 again, in a state where the tray 120 and the frame 110 are combined, the flange 121 of the tray 120 is placed on the upper surface of the frame 110, and the housing portion 122 of the tray 120 is disposed in the through hole TH of the frame 110. At this time, the projecting portion 122c is disposed so as to partially cover the cross member 113. Although an exploded view is virtually shown in FIG. 4 for the sake of illustration, the tray 120 is integrated in a combined state as shown in FIG. 3 by being brought into pressure contact with the frame 110 and the three cross members 113.

Referring to FIG. 2 again, the battery 30 is disposed in the housing portion 122 of the tray 120. Hermetically sealing the housing portion 122 with the top cover 130 from above the battery 30 houses the battery 30 in the battery case 100. The hermetic sealing structure prevents water from entering the battery case 100 from the outside. In particular, since the tray 120 is formed in a bathtub shape, there is no joint in the tray 120, and high sealing performance capable of preventing water from entering from a road surface or the like can be secured. In addition, a safety valve for pressure adjustment inside the battery case 100 may be provided.

In the example in FIG. 2, the top cover 130 and the tray 120 are fastened and fixed to the frame 110 by screws. Above the top cover 130, a floor panel 300 constituting a floor surface of the vehicle interior R and a floor cross member 400 extending in the vehicle width direction in the vehicle interior R are disposed. In addition, an under cover 140 is disposed below the tray 120. The under cover 140 is screwed to each of the frame 110 and the cross member 113 to support the tray 120 from below.

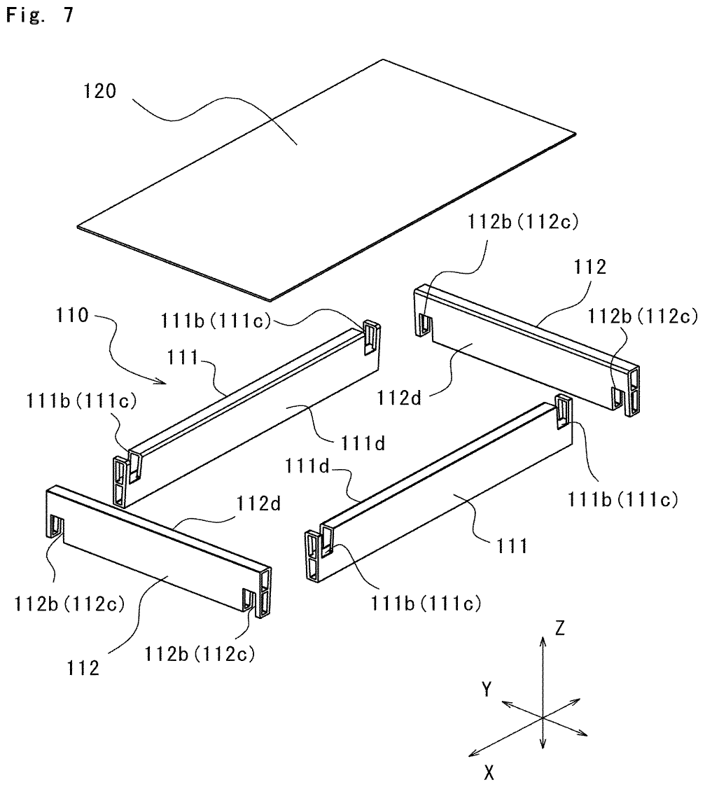

A method for manufacturing the battery case 100 having the above configuration will be described with reference to FIGS. 7 to 11.

Referring to FIG. 7, a flat plate-shaped member to be formed 120, a first framework member 111, and a second framework member 112 are prepared. Then, by engaging the first engagement portion 111b with the second engagement portion 112b, the first framework member 111 and the second framework member 112 are joined to constitute a frame 110 having a rectangular frame shape when viewed from the vehicle vertical direction and defining the through hole TH on the inner side (see FIG. 4).

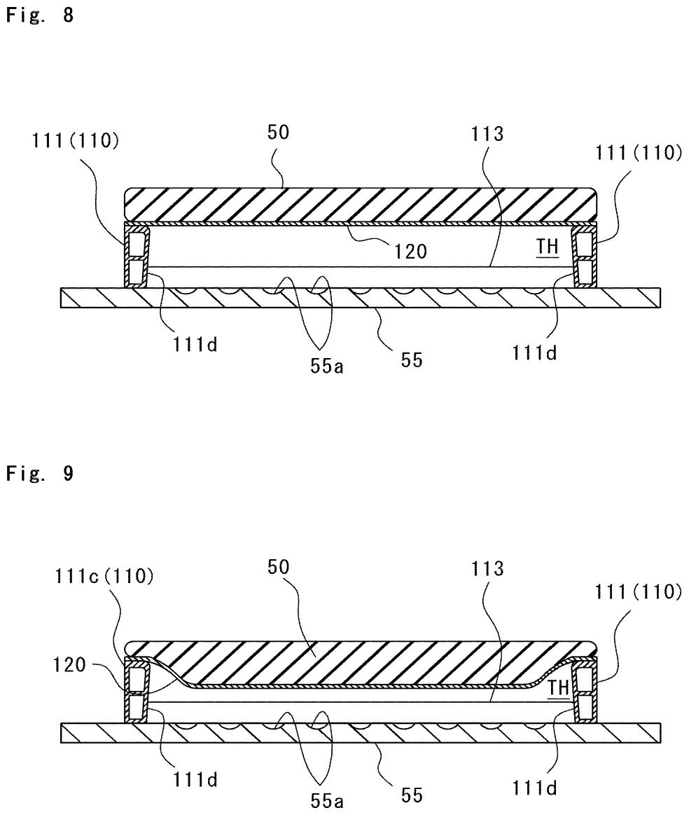

Referring to FIG. 8, the member to be formed 120 is superposed on the frame 110 to be disposed on the table 55. A recessed portion 55a having a shape corresponding to the groove 124 is formed on the upper surface of the table 55 in order to form the groove 124 in the tray 120 as described below. It should be noted that the same reference numeral 120 is used for the member to be formed and the tray, which means that the state before forming is the member to be formed and the state after forming is the tray.

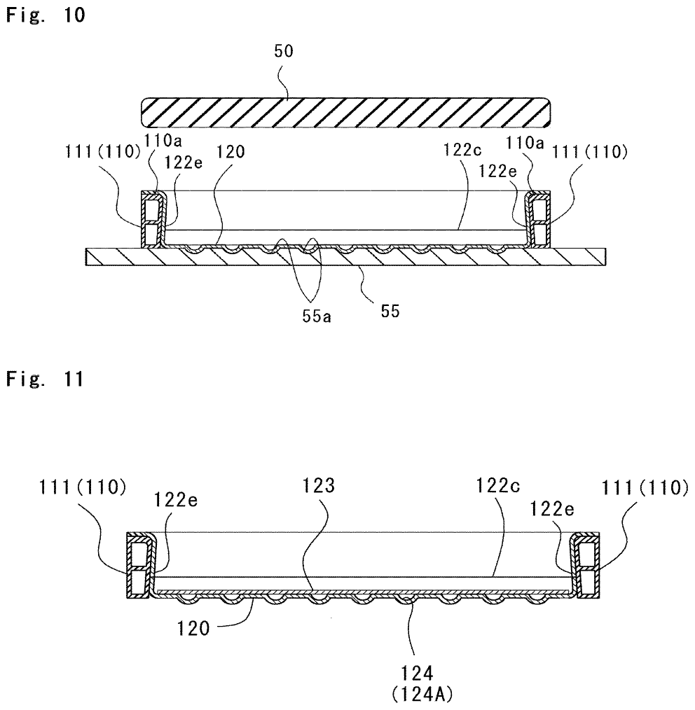

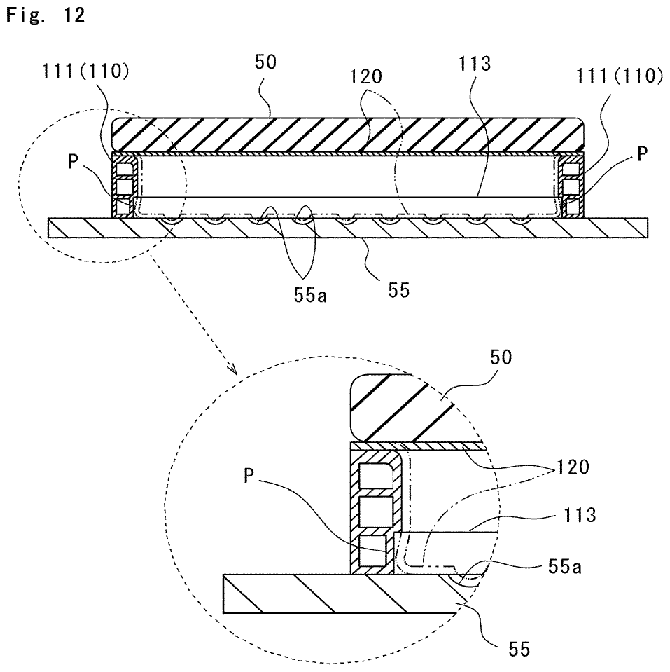

Next, with reference to FIGS. 9 and 10, pressure is applied to the member to be formed 120 from the side opposite to that of the frame 110 (that is, the upper side), and the member to be formed 120 is pressed against the frame 110 to swell in the through hole TH, thereby deforming the member to be formed 120 into a bathtub-shaped tray 120 and bringing the member to be formed 120 into pressure contact with the frame 110. At this time, the member to be formed 120 is also brought into pressure contact with the three cross members 113. As a result, the tray 120, the frame 110, and the three cross members 113 are integrated.

In the present embodiment, the pressurization against the member to be formed 120 is performed by a pressure forming method (rubber bulging method) using an elastic body. The pressure forming method refers to a method of forming a member by gas or liquid pressure. In the present embodiment, in the rubber bulging method, the hydraulic transfer elastic body 50 that is elastically deformable using the pressure of the liquid is used. The hydraulic transfer elastic body 50 may have a structure in which only a lower surface of a metal chamber containing a liquid such as water or oil is closed with an elastic film, for example. In such a hydraulic transfer elastic body 50, the elastic film is deformed by adjusting the pressure of the liquid, and forming can be performed without the liquid coming into direct contact with the member to be formed 120.

Referring to FIGS. 8 and 9, in the present embodiment, the frame 110, the member to be formed 120, and the hydraulic transfer elastic body 50 are superposed and disposed in this order on the table 55, and the member to be formed 120 is pressurized and pressed against the frame 110 through the hydraulic transfer elastic body 50. Preferably, pressurization of the member to be formed 120 by the rubber bulging method is performed in a state where the member to be formed 120 is heated and softened. In this case, due to the softening of the member to be formed 120, cracking during forming of the tray 120 can be further suppressed.

In addition, on the upper surface of the table 55, a recessed portion 55a having a shape corresponding to the groove 124 is formed so that the groove 124 can be formed in the tray 120. Therefore, a groove 124 (see FIG. 5) is formed on the bottom wall 122a of the tray 120 along with the pressurization by the hydraulic transfer elastic body 50. That is, in the present embodiment, the member to be formed 120 is formed into the tray 120 having a bathtub shape, and the groove 124 is formed on the bottom wall 122a of the housing portion 122 of the tray 120. Although not shown in detail, in addition to the forming of the groove 124, a protrusion for positioning the battery 30 may be formed on the tray 120.

Referring to FIG. 10, when the pressurizing force is released after the member to be formed 120 is deformed into the bathtub-shaped tray 120, the hydraulic transfer elastic body 50 is restored to a shape in the natural state. Therefore, the hydraulic transfer elastic body 50 can be easily removed from the inside of the tray 120. After the hydraulic transfer elastic body 50 is removed, as shown in FIG. 2, the closing plate 123 and the under cover 140 are joined to house the battery 30, and then the top cover 130 is joined to form the battery case 100.

In the present embodiment, in the frame 110, the wall thickness of the upper portion 110a is set to be larger than that of another portion. The upper portion 110a of the frame 110 is a portion susceptible to force due to the forming described above, and increasing the wall thickness of the portion prevents unintended deformation. In addition, an R shape (rounded shape) is imparted to the inner side of the upper portion 110a of the frame 110. The R shape prompts the material to flow into the member to be formed 120 in the forming. However, in view of the design of the extruded material or the like, a small R shape may be formed on a portion in addition to the inner side of the upper portion 110a of the frame 110. In the drawings, let such a small R shape be omitted.

In the present embodiment, when the member to be formed 120 is formed into the bathtub-shaped tray 120, negative angle forming is performed. Here, the negative angle is a term often used in the forming field using a die, and indicates that the die draft angle in the formed member is less than zero (negative). In the present embodiment, the tray 120 is pressed against the inclined surfaces 111d and 112d of the frame 110 by pressurization from the hydraulic transfer elastic body 50, and the tray 120 is provided with a negative angle portion 122e in which a negative angle directed upward in the vehicle vertical direction from the bottom wall 122a of the tray 120 toward the inside in the horizontal direction is formed.

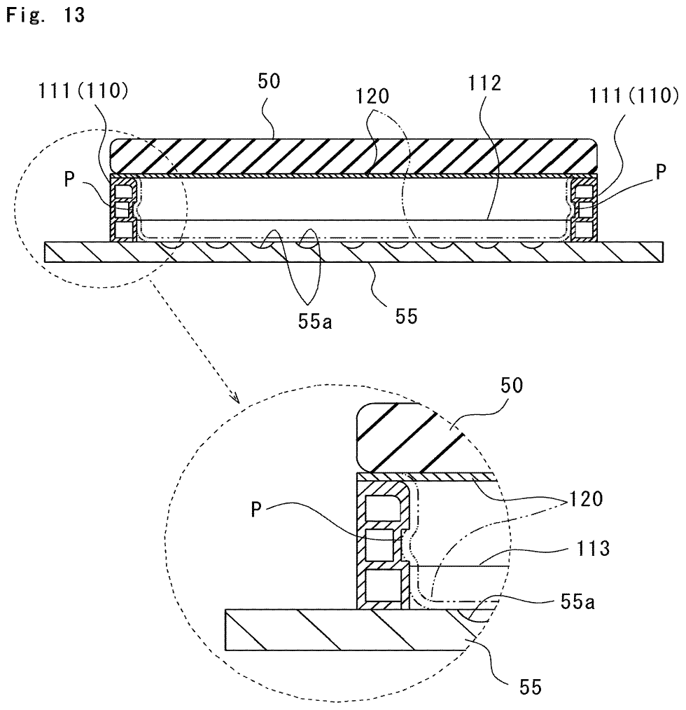

Next, referring to FIG. 11, the closing plate 123 is disposed and joined to the bottom wall 122a of the tray 120 so as to close the groove 124 formed as described above. The closing plate 123 is disposed on the housing portion 122 of the tray 120 from above, and is joined by, for example, an FSW. In this manner, the closing plate 123 and the groove 124 define a coolant flow path 124A through which a coolant flows.

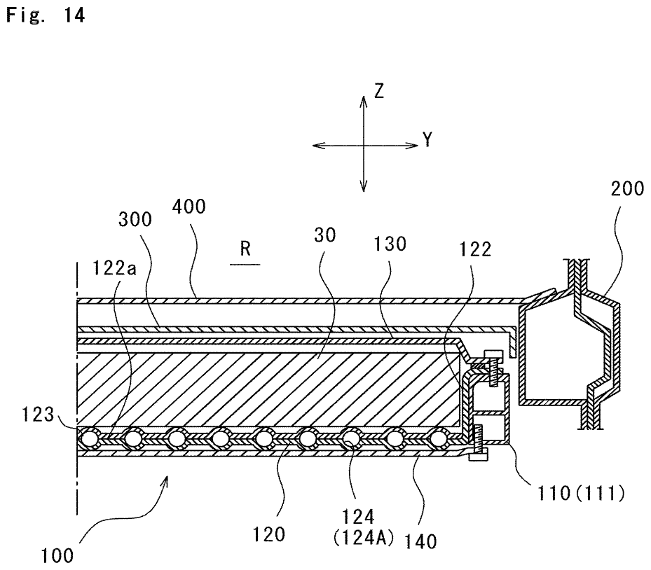

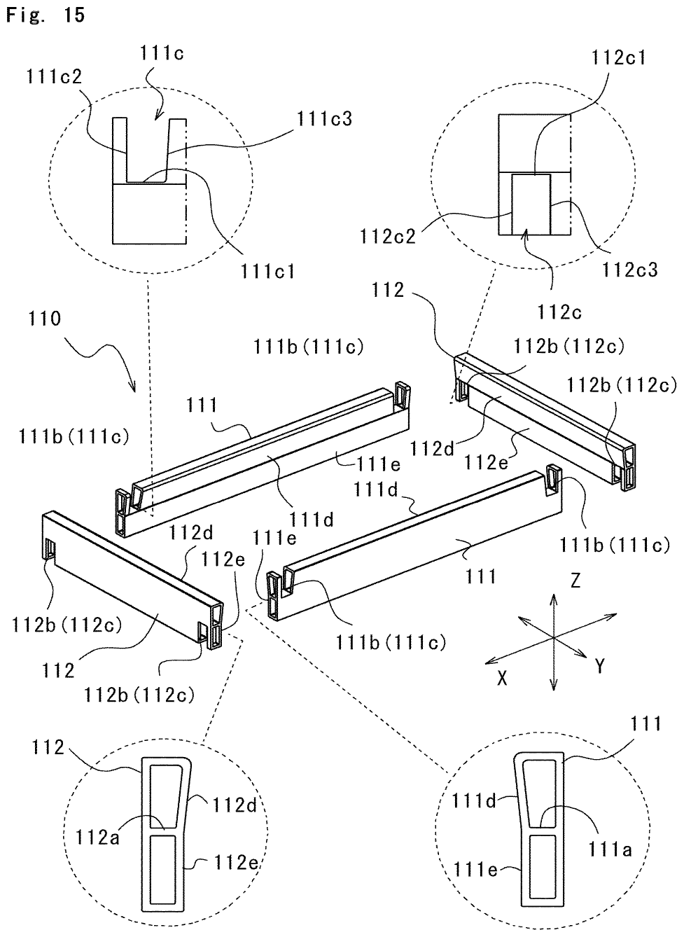

In addition, as shown in FIGS. 12 and 13 as a modification of the negative angle forming, a recessed portion P having a recessed shape may be provided on the inner surface of the frame 110. In this case, the negative angle forming is performed by pressing the member to be formed 120 against the recessed portion P of the frame 110. In the example in FIG. 12, the recessed portion P is provided at the lowermost portion of the frame 110. In the example in FIG. 13, the recessed portion P is provided at the central portion of the frame 110. In addition, such a recessed portion may also be provided in the three cross members 113. Thus, by providing the recessed portion P in the frame 110, it is possible to easily and reliably execute the negative angle forming that forms the negative angle portion 122e in the tray 120.

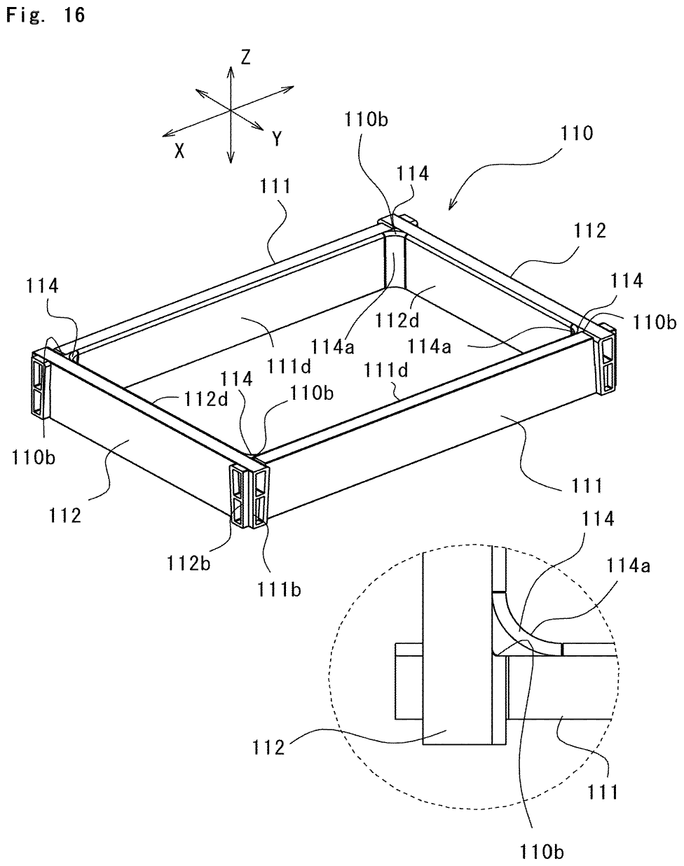

In addition, as a modification of the closing plate 123, an uneven shape may be imparted to the closing plate 123 as shown in FIG. 14. In the configuration described above, the closing plate 123 having a flat surface is exemplified, but an upward protruding shape (downward recessed shape) may be imparted to the closing plate 123 in accordance with the shape of the groove 124 so as to enlarge the flow path area of the coolant flow path 124A. In the example in FIG. 14, a semicircular shape vertically symmetrical with respect to the semicircular shape of the groove 124 is imparted to the closing plate 123. In this way, by enlarging the flow path area of the coolant flow path 124A, the flow rate of the coolant can be increased, and the cooling performance can be improved.

According to the battery case 100 and the method for manufacturing the same as described above, the following actions and effects are produced.

By engaging the first engagement portion 111b with the second engagement portion 112b, the first framework member 111 and the second framework member 112 are directly joined, so that complicated welding is not required. Therefore, thermal damage to the frame 110 can be suppressed, and the frame 110 can be simply configured. Since the first engagement portion 111b and the second engagement portion 112b enable accurate positioning of the first framework member 111 and the second framework member 112, dimensional accuracy and joining accuracy can be improved. In addition, since the tray 120 is formed in a bathtub shape, there is no joint in the tray 120, and high sealing performance capable of preventing water from entering from a road surface or the like can be secured.

In addition, in the first engagement portion 111b and the second engagement portion 112b, the recessed portions 111c and 112c recessed in the vehicle vertical direction are fitted to each other, so that the positions of the first framework member 111 and the second framework member 112 in the horizontal direction are restrained. In addition, since the bathtub-shaped tray 120 is disposed on the frame 110 from above, the first engagement portion 111b and the second engagement portion 112b may be covered with the tray 120. Therefore, the position in the vehicle vertical direction is also restrained, and the engagement can be prevented from being released.

In addition, since the frame 110 and the tray 120 are brought into pressure contact with each other, the frame 110 and the tray 120 can be easily integrated without requiring welding. At this time, the manufacturing step can be simplified by simultaneously performing the forming of the bathtub-shaped tray and the pressure contact between the tray and the frame.

In addition, even when an upward force is applied to the tray 120, the negative angle portion 122e is caught by the frame 110, so that the tray 120 can be prevented from being detached from the frame 110. That is, the pressure contact between the tray 120 and the frame 110 can be prevented from being released.

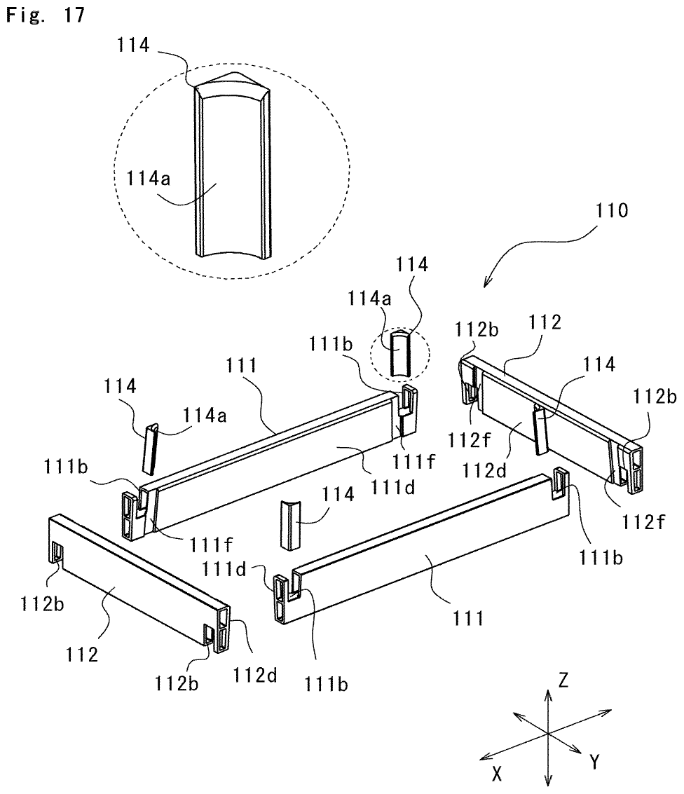

It should be noted that the shape of the frame 110 for performing the negative angle forming is not limited to that of the above embodiment. For example, as shown in FIG. 15, the inclined surface 111d of the first framework member 111 may be only the upper half. At this time, the lower half of the first framework member 111 may be a vertical surface 111e along the vertical direction. Similarly, the inclined surface 112d of the second framework member 112 may have only the upper half. At this time, the lower half of the second framework member 112 may be a vertical surface 112e along the vertical direction.

### Second Embodiment

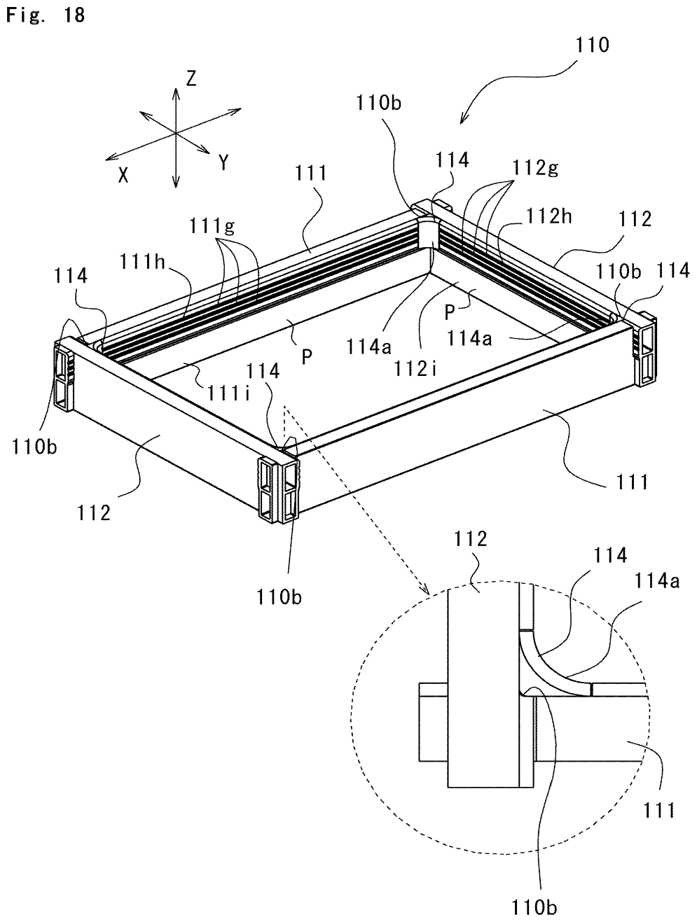

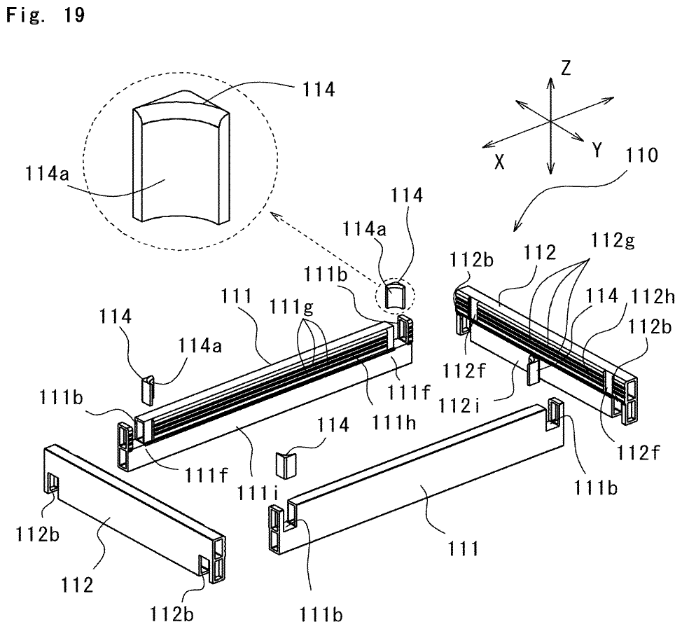

The second embodiment shown in FIGS. 16 and 17 is different from the first embodiment in the configuration related to the frame 110 and the corner member 114. Those other than the configurations related to these are substantially the same as those of the first embodiment. Therefore, descriptions of the portions shown in the first embodiment may be omitted.

In the present embodiment, the frame 110 has recessed-shaped attachment portions 111f and 112f (see FIG. 17) complementary to the corner member 114 at an inner corner portion 110b (see FIG. 16) when viewed from the vehicle vertical direction. Corner members 114 are disposed on the attachment portions 111f and 112f.

The corner member 114 has a curved surface 114a that smoothly connects the inclined surface 111d on the inner side of the first framework member 111 and the inclined surface 112d on the inner side of the second framework member 112. The curved surface 114a may have, for example, a circular arc shape when viewed from the vehicle vertical direction. Therefore, when viewed from the vehicle vertical direction, the inner shape of the assembly including the frame 110 and the corner members 114 is a corner-rounded quadrangle. It should be noted that the corner member 114 has substantially the same height as the frame 110 in the vehicle vertical direction.

The method for manufacturing the battery case 100 of the present embodiment is substantially the same as that of the first embodiment except that the corner member 114 is disposed at the inner corner portion 110b (see FIG. 16) of the frame 110.

The actions and effects of the battery case 100 having the above-described configuration and the method for manufacturing the same are also substantially the same as those of the first embodiment. However, in the present embodiment, at the time of pressure contact between the tray 120 and the frame 110, the tray 120 is pressed against the curved surface 114a, at the inner corner portion 110b of the frame 110. If the corner member 114 is not disposed, there is a risk that the corner portion 122b1 (see FIG. 4) of the tray 120 is broken due to concentration of strain. However, when the corner member 114 is disposed, since the corner portion 122b1 of the tray 120 is supported by the corner member 114 at the time of the pressure contact, the concentration of stress on the corner portion 122b1 of the tray 120 can be suppressed, and cracking of the tray 120 can be suppressed.

In addition, referring to FIGS. 18 and 19, the height of the corner member 114 does not need to be substantially the same as that of the frame 110. For example, the corner member 114 may have a height of about half of that of the frame 110 in the vehicle vertical direction, or may be disposed only at about the upper half of the frame 110. Accordingly, the attachment portions 111f and 112f may also be formed only at about the upper half of the frame 110. In addition, a plurality of grooves 111g and 112g may be formed on the inner upper half surfaces 111h and 112h of the frame 110. The plurality of grooves 111g and 112g may further strengthen the pressure contact between the frame 110 and the tray 120. In the examples in FIGS. 18 and 19, the inner upper half surfaces 111h and 112h and the inner lower half surfaces 111i and 112i of the frame 110 are both surfaces along the vertical direction. The upper half surfaces 111h and 112h are positioned further inside the frame 110 than the lower half surfaces 111i and 112i. Therefore, in the present modification, the lower half surfaces 111i and 112i constitute the recessed portion P, and negative angle forming can be performed.

As described above, although the specific embodiments and their modifications of the present disclosure are described, the present disclosure is not limited to the above-described embodiments, and can be implemented with various modifications within the scope of the present invention. For example, an appropriate combination of contents of the individual embodiments and modifications may be one embodiment of the present invention.

The present disclosure may include the following aspects.

### Aspect 1

An electric vehicle battery case including:
a frame formed in a polygonal frame shape when viewed from a vehicle vertical direction by joining a plurality of framework members, the frame configured to define a space inside; and
a tray having a bathtub shape configured to house a battery, the tray disposed at least partially in the space of the frame,
wherein the plurality of framework members includes a first framework member that is made of an aluminum extruded material and has a first engagement portion at an end portion, and a second framework member that is made of an aluminum extruded material and has a second engagement portion at an end portion,
the first engagement portion and the second engagement portion have shapes to be engaged with each other, and
the first framework member and the second framework member are directly joined by engagement of the first engagement portion and the second engagement portion.

### Aspect 2

The electric vehicle battery case according to aspect 1, wherein at least one of the first engagement portion and the second engagement portion has a recessed shape.

### Aspect 3

The electric vehicle battery case according to aspect 1 or 2, wherein
the first engagement portion includes a recessed portion having a shape recessed downward in the vehicle vertical direction, and
the second engagement portion includes a recessed portion having a shape recessed upward in the vehicle vertical direction.

### Aspect 4

The electric vehicle battery case according to any one of aspects 1 to 3, wherein the tray is brought into pressure contact with the frame.

### Aspect 5

The electric vehicle battery case according to aspect 4, wherein a negative angle portion in which a negative angle directed at least partially inward in a horizontal direction from a bottom wall of the tray toward an upper side in the vehicle vertical direction is formed is provided.

### Aspect 6

The electric vehicle battery case according to aspect 4 or 5, wherein a corner member having a curved surface is disposed at an inner corner portion of the frame when viewed from the vehicle vertical direction.

### Aspect 7

A method for manufacturing an electric vehicle battery case, the method including:
preparing a member to be formed having a flat-plate shape and a plurality of framework members, the plurality of framework members including a first framework member that is made of an aluminum extruded material and has a first engagement portion at an end portion and a second framework member that is made of an aluminum extruded material and has a second engagement portion at an end portion, the first engagement portion and the second engagement portion having shapes to be engaged with each other;
joining the first framework member and the second framework member by engaging the first engagement portion and the second engagement portion to form a frame having a polygonal frame shape when viewed from a vehicle vertical direction and defining a space inside;
superposing and disposing the member to be formed on the frame; and
applying pressure to the member to be formed from a side opposite to that of the frame, pressing the member to be formed against the frame, swelling the member to be formed in the space, resulting in deforming the member to be formed into a tray having a bathtub shape and bringing the member to be formed into pressure contact with the frame.

This application claims priority based on Japanese Patent Application No. 2022-036044 filed on Mar. 9, 2022. Japanese Patent Application No. 2022-036044 is incorporated herein by reference.

### EXPLANATION OF REFERENCES

1 electric vehicle
10 vehicle body front portion
20 vehicle body central portion
30 battery
50 hydraulic transfer elastic body
55 table
55a recessed portion
100 electric vehicle battery case (battery case)
110 frame
110a upper portion
110b inner corner portion
111 first framework member (framework member)
111a partition wall
111b first engagement portion
111c recessed portion
111c1 bottom surface
111c2, 111c3 side surface
111d inclined surface
111e vertical surface
111f attachment portion
111g groove
111h upper half surface
111i lower half surface
112 second framework member (framework member)
112a partition wall
112b second engagement portion
112c recessed portion
112c1 top surface
112c2, 112c3 side surface
112d inclined surface
112e vertical surface
112f attachment portion
112g groove
112h upper half surface
112i lower half surface
113 cross member
114 corner member
114a curved surface
120 tray (member to be formed)
121 flange
122 housing portion
122a bottom wall
122b peripheral wall
122b1 corner portion
122c projecting portion
122d opening
122e negative angle portion
123 closing plate
124 groove
124a inlet
124A coolant flow path
124b outlet
130 top cover
140 under cover
200 rocker member
300 floor panel
400 floor cross member
P recessed portion

1. An electric vehicle battery case comprising:
a frame formed in a polygonal frame shape when viewed from a vehicle vertical direction by joining a plurality of framework members, the frame configured to define a space inside; and
a tray having a bathtub shape configured to house a battery, the tray disposed at least partially in the space of the frame, wherein
the plurality of framework members includes a first framework member that is made of an aluminum extruded material and has a first engagement portion at an end portion, and a second framework member that is made of an aluminum extruded material and has a second engagement portion at an end portion,
the first engagement portion and the second engagement portion have shapes to be engaged with each other, and
the first framework member and the second framework member are directly joined by engagement of the first engagement portion and the second engagement portion.

2. The electric vehicle battery case according to claim 1, wherein at least one of the first engagement portion and the second engagement portion has a recessed shape.

3. The electric vehicle battery case according to claim 1, wherein
the first engagement portion includes a recessed portion having a shape recessed downward in the vehicle vertical direction, and
the second engagement portion includes a recessed portion having a shape recessed upward in the vehicle vertical direction.

4. The electric vehicle battery case according to claim 2, wherein
the first engagement portion includes a recessed portion having a shape recessed downward in the vehicle vertical direction, and
the second engagement portion includes a recessed portion having a shape recessed upward in the vehicle vertical direction.

5. The electric vehicle battery case according to claim 1, wherein the tray is brought into pressure contact with the frame.

6. The electric vehicle battery case according to claim 5, wherein a negative angle portion in which a negative angle directed at least partially inward in a horizontal direction from a bottom wall of the tray toward an upper side in the vehicle vertical direction is formed is provided.

7. The electric vehicle battery case according to claim 5, wherein a corner member having a curved surface is disposed at an inner corner portion of the frame when viewed from the vehicle vertical direction.

8. The electric vehicle battery case according to claim 6, wherein a corner member having a curved surface is disposed at an inner corner portion of the frame when viewed from the vehicle vertical direction.

9. A method for manufacturing an electric vehicle battery case, the method comprising:
preparing a member to be formed having a flat-plate shape and a plurality of framework members, the plurality of framework members including a first framework member that is made of an aluminum extruded material and has a first engagement portion at an end portion and a second framework member that is made of an aluminum extruded material and has a second engagement portion at an end portion, the first engagement portion and the second engagement portion having shapes to be engaged with each other;
joining the first framework member and the second framework member by engaging the first engagement portion and the second engagement portion to form a frame having a polygonal frame shape when viewed from a vehicle vertical direction and defining a space inside;
superposing and disposing the member to be formed on the frame; and
applying pressure to the member to be formed from a side opposite to that of the frame, pressing the member to be formed against the frame, swelling the member to be formed in the space, resulting in deforming the member to be formed into a tray having a bathtub shape and bringing the member to be formed into pressure contact with the frame.

10. The electric vehicle battery case according to claim 2 wherein the tray is brought into pressure contact with the frame.

11. The electric vehicle battery case according to claim 3 wherein the tray is brought into pressure contact with the frame.

12. The electric vehicle battery case according to claim 4 wherein the tray is brought into pressure contact with the frame.

13. The electric vehicle battery case according to claim 10, wherein a negative angle portion in which a negative angle directed at least partially inward in a horizontal direction from a bottom wall of the tray toward an upper side in the vehicle vertical direction is formed is provided.

14. The electric vehicle battery case according to claim 11, wherein a negative angle portion in which a negative angle directed at least partially inward in a horizontal direction from a bottom wall of the tray toward an upper side in the vehicle vertical direction is formed is provided.

15. The electric vehicle battery case according to claim 12, wherein a negative angle portion in which a negative angle directed at least partially inward in a horizontal direction from a bottom wall of the tray toward an upper side in the vehicle vertical direction is formed is provided.

16. The electric vehicle battery case according to claim 10, wherein a corner member having a curved surface is disposed at an inner corner portion of the frame when viewed from the vehicle vertical direction.

17. The electric vehicle battery case according to claim 11, wherein a corner member having a curved surface is disposed at an inner corner portion of the frame when viewed from the vehicle vertical direction.

18. The electric vehicle battery case according to claim 12, wherein a corner member having a curved surface is disposed at an inner corner portion of the frame when viewed from the vehicle vertical direction.

19. The electric vehicle battery case according to claim 13, wherein a corner member having a curved surface is disposed at an inner corner portion of the frame when viewed from the vehicle vertical direction.

20. The electric vehicle battery case according to claim 14, wherein a corner member having a curved surface is disposed at an inner corner portion of the frame when viewed from the vehicle vertical direction.
